(19) United States
(12) Patent Application Publication
(10) Pub. No.: US 2022/0190324 A1
(43) Pub. Date: Jun. 16, 2022

(54) NANOPARTICLES HAVING POLYTHIONATE CORES

(71) Applicant: Conamix Inc., Ithaca, NY (US)

(72) Inventors: Jay J. Farmer, Ithaca, NY (US); Stephen Burkhardt, Ithaca, NY (US)

(21) Appl. No.: 17/442,542

(22) PCT Filed: Mar. 25, 2020
(86) PCT No.: PCT/US2020/024725

§ 371 Date: Sep. 23, 2021

Related U.S. Application Data
(60) Provisional application No. 62/823,765, filed on Mar. 26, 2019.

(51) Int. Cl. H01M 4/36; H01M 4/62; H01M 4/38; H01M 10/0525; H01M 4/58

(52) U.S. Cl. CPC H01M 4/366; H01M 4/624; B82Y 40/00; H01M 10/0525; H01M 4/5815; H01M 4/382

(57) ABSTRACT

This application relates to nanoparticles having improved electroactive cores comprising polythionate molecules (e.g. compounds with a structure ⁻O₃S—(S)ₙ—SO₃⁻) encapsulated in shells, such as those that may be used as electrode materials for secondary batteries or other energy storage devices, and methods of making same.

### CROSS REFERENCE TO RELATED APPLICATIONS

This application claims priority to and benefit of U.S. Application Ser. No. 62/823,765, filed on Mar. 26, 2019, the contents of which is incorporated by reference in its entirety.

### TECHNICAL FIELD

This application relates to nanoparticles having improved electroactive cores encapsulated in shells, such as those that may be used as electrode materials for secondary batteries or other energy storage devices, and methods of making same.

### BACKGROUND

A major objective in commercial development of next generation rechargeable batteries is to provide batteries with higher energy densities and lower cost than state of the art lithium ion batteries. One of the most promising approaches towards achieving this goal relies on use of a sulfur cathode. Sulfur is extremely attractive because it is inexpensive, abundant, and offers a theoretical charge capacity that is an order of magnitude higher than conventional metal oxide-based intercalation cathodes used in current lithium ion cells. However, manufacture of a practical sulfur battery has been an elusive goal. Among the numerous challenges that plague sulfur cathodes, some of the most serious arise from: (1) the fact that sulfur is insoluble and electrically insulating; and (2) that lithium polysulfide intermediates, which form during battery discharge are highly soluble in electrolyte and difficult to retain at a cathode. The first challenge presented leads to high impedance and low sulfur utilization, while the second leads to a polysulfide shuttle that decreases battery efficiency and leads to anode fouling.

Thus, although elemental sulfur has been under investigation as a battery cathode material for more than 50 years, certain fundamental challenges have yet to be overcome. To produce a viable cathode material, conductivity of elemental sulfur must first be enhanced. Unlike commercial lithium ion cathodes containing LiCoO₂, which possess a high electronic conductivity and do not require significant addition of conductive additives, sulfur is an insulator, and therefore, in order to prepare a viable and commercially useful battery based on an elemental sulfur cathode, active material must be present in a structure that enhance electrochemical accessibility of sulfur. Attempts to address these challenges have included use of nanoporous monoliths and engineered nanomaterials such as core shell particles, nanotubes and laminates.

In addition, diffusion and subsequent loss of polysulfide intermediates that are formed during electrochemical cycling must be controlled to produce a viable electrochemical cell. During discharge, sulfur reduces in a stepwise manner by forming a series of polysulfide intermediates that are ionic in nature, dissolve readily in the electrolyte, and may be lost by migration to the anode causing mass loss of active material upon cycling and anode fouling.

To date, technical approaches taken to address and solve these fundamental challenges have resulted in diminished charge capacity in comparison to the theoretical value of sulfur.

Although incremental improvements in capacity and cycle life have been made, significantly greater improvements in stabilization of elemental sulfur to polysulfide loss is necessary in order to produce commercially viable metal-sulfur batteries. Thus, there is a need for a sulfur active material which allows for complete utilization of sulfur while minimizing loss of polysulfide.

An objective of the present disclosure is to provide structured nanomaterials suitable for utilization as a cathode active material that is capable of providing good sulfur utilization, while effectively containing soluble polysulfides to prevent their loss or migration.

### SUMMARY

Generally, this disclosure relates to improved nanoparticles, such as those for use in electrodes for an energy storage device. In particular, the disclosure relates to improved nanoparticle cores and methods of making same. The present invention provides, among other things, nanoparticles comprising a shell (e.g., polymeric, inorganics, elemental carbon, metal oxides, sulfides, etc.) and an electroactive core comprising polythionate molecules (e.g. compounds with a structure ⁻O₃S—(S)ₙ—SO₃⁻) disposed within the shell. In some embodiments, an electroactive core comprises compounds with a structure (S)ₙ—SO₃⁻. The present invention encompasses the recognition that such nanoparticles offer particular advantages as cathode materials. For example, nanoparticle cores that comprise polythionates and/or other non-electrochemically active compounds can improve battery performance (e.g., battery capacity may vary depending on the Sₙ to SO₃⁻ ratio in the particles). These cores, in some embodiments, comprise monodispersed constituents with particle size and solubility optimized for particular applications. Additionally, in some embodiments,—SO₃⁻ anions are lithiated and aid in ion conductivity, solvation, and polysulfide trapping. Furthermore, in some embodiments, anionic polythionate particle surfaces may template polymer shell synthesis and/or dope a polymer (e.g., polyaniline). Further advantages of nanoparticles having such cores are explained below.

In one aspect, the present disclosure relates to a core-shell nanoparticle including a shell defining an internal volume and a sulfur-based core with a composition different from said shell and disposed within an internal volume defined by said shell. In some embodiments, a sulfur-based core includes polythionate and/or another electrochemically active compound, along with optional additives.

In another aspect, the present disclosure relates to a core-shell nanoparticle including a shell defining an internal volume and a core made up of a composite of lithium thiosulfate and lithium sulfide disposed within an internal volume defined by said shell.

In yet another aspect, the present disclosure relates to an electrode for an energy storage device, such as a secondary battery, a capacitor, or other electrochemical system. In some embodiments, an electrode includes a nanoparticle as described herein, for example, having a core-shell nanoparticle including a shell defining an internal volume and a sulfur-based core with a composition different from said shell and disposed within an internal volume defined by said shell. In some embodiments, the sulfur-based core includes polythionate.

In another aspect, the present disclosure relates to an energy storage device including an anode, a cathode having a core shell nanoparticle with a shell defining an internal volume and a sulfur-based core including polythionate disposed within an internal volume defined by said shell, a separator, and an electrolyte. In still another aspect, the present disclosure relates to an energy storage device including an anode, a cathode including lithium polythionate, a separator, and an electrolyte. It will be appreciated that when charged, such an energy storage device will contain a cathode substantially free of lithium (e.g., comprising an anode, a cathode including lithium polythionate, a separator, and an electrolyte).

In various embodiments of the foregoing aspects, a sulfur-based core includes a polythionate composition having a plurality of molecules of formula ⁻O₃S—(S)ₙ—SO₃⁻, wherein n is on average in the composition between about 1 and about 40 (e.g., between about 4 and about 40). In various embodiments of the foregoing aspects, a sulfur-based core includes a composition having a plurality of molecules of formula (S)ₙ—SO₃⁻, wherein n is on average in said composition between about 1 and about 40. In some embodiments, a sulfur-based core includes elemental sulfur. In some embodiments, a mass ratio of polythionate to elemental sulfur in a sulfur-based core is between about 1:10 and about 10:1. In various embodiments, a molar ratio of —SO₃⁻ functional groups to S⁰ atoms in the core is at least about 1:200, preferably, at least about 1:100, at least about 1:50, at least about 1:40, or at least about 1:25).

In some embodiments, a core-shell nanoparticle includes lithium (Li), such as lithium polythionate; however, counter ions other than Li, such as sodium, potassium, rubidium, magnesium, zinc or calcium are contemplated and considered within the scope of the present disclosure. In some embodiments, a core can also include one or more conductive additives, such as carbon, graphite, carbon nanotubes, graphene, metal oxides, metal chalcogenides, and conductive polymers. In some embodiments, a sulfur-based core includes a composite of elemental sulfur, polythionate and a conductive additive. In certain embodiments of core-shell nanoparticles described herein, polythionate comprises less than about 25 wt. % of a core, less than about 20 wt. %, less than about 15 wt. %, or less than about 10 wt. %. In some embodiments, polythionate comprises about 1 to about 10 wt. % of a core. Generally, it is desirable for about 80% or greater of the nanoparticle to comprise electroactive material.

In some embodiments, a core-shell nanoparticle includes a polymer shell, which in some instances comprises a conductive polymer. In some embodiments, a polymer shell comprises polyaniline. Additionally or alternatively, a shell can include an inorganic material. In various embodiments, a shell can include a transition metal oxide, such as manganese dioxide (MnO₂), iron oxide black or magnetite (Fe₃O₄), titanium dioxide (TiO₂), or molybdenum trioxide (MoO₃), In some embodiments, a shell can include a transition metal sulfide, such as titanium disulfide (TiS₂), molybdenum disulfide (MoS₂), iron sulfide (FeS), greigite (Fe₃S₄), or iron disulfide (FeS₂). In various embodiments, a shell includes a composite of one or more polymers with at least one conductive additive, such as carbon, graphite, carbon nanotubes, graphene, metal oxides, metal chalcogenides, or metal-organic frameworks.

In some embodiments, a dimension (e.g., a diameter or length) of a nanoparticle is between about 20 and about 1500 nm, between about 20 and about 1000 nm, between about 200 and about 1200 nm, between about 100 and about 900 nm, between about 200 and about 800 nm, or between about 400 and about 800 nm. In some embodiments, the nanoparticle is substantially spherical, a nanowire, or a plate; however, other shapes (e.g., ovoid, polyhedral, of irregular shape, or combination thereof) are contemplated and considered within the scope of the present disclosure. In various embodiments, a sulfur-based core occupies only a portion of an internal volume defined by a shell, for example, a sulfur-based core occupies between about 20% and 80% of an internal volume defined by a shell. In some embodiments, a shell of a nanoparticle has a thickness of between about 5 and about 50 nm, and in some instances, includes two or more layers. In some embodiments, two or more layers of a nanoparticle shell have different compositions, for example, in some such embodiments, at least one layer is a polymer and at least one layer is an elemental carbon or an inorganic composition.

In another aspect, the present disclosure relates to a method of producing a sulfur-based composite comprising polythionate. For example, a method can include compositing elemental sulfur with lithium thiosulfate or partially oxidizing an elemental sulfur nanoparticle. These composites can be provided in various forms, such as powders, pellets, or in a solution as a slurry, with or without other additives.

In some embodiments, a method is directed to producing a core-shell nanoparticle. In some embodiments, a method includes steps of: introducing sodium thiosulfate to an acid solution (e.g., hydrochloric, formic, or sulfuric); reacting sodium thiosulfate in solution to precipitate sulfur-based core materials (e.g., a finished core or an intermediate product); and controlling said reaction. In some embodiments, a reaction can be controlled by at least one of: introducing an oxidizing agent to said acid solution, adjusting a pH of said solution, varying an environmental condition (e.g., solution and/or ambient temperature, exposure to UV radiation, etc.), adding a surfactant to said acid solution, limiting mixing time (e.g., continuous vs. intermittent stirring, stirring during a gradual introduction of sodium thiosulfate); or washing (e.g., rinsing core material or introducing core material to another solution). In some embodiments, potassium thiosulfate may be used instead of sodium thiosulfate.

In various embodiments, a method further includes a step of introducing a polymer to the acid solution to encapsulate a core (e.g., 1% (weight ratio) of polyvinylpyrrolidone (PVP), Mw about 40,000). In certain embodiments, precipitated cores can undergo further processing, such as introduction to additional solutions comprising additional polymers (e.g., polyaniline) or other additives (e.g., a conductive carbon), to finalize the core. In some embodiments, an oxidizing agent is selected from the group consisting of a peroxymonosulfate [HSO₅]⁻, a permanganate [MnO₄]⁻, a dichromate [Cr₂O₇]²⁻, a chromate [CrO₄]⁻, a bromate salt [BrO₃]⁻, a hypochlorite salt [ClO]⁻, a chlorate [ClO₃]⁻, a perchlorate [ClO₄]⁻, a periodate [IO₄]⁻, a vanadate salt, or a nitrate [NO₃]⁻, where a counter cation is selected from the group consisting of Li⁺, Na⁺, K⁺, Ag⁺, Mg²⁺, or Ca²⁺, a metal oxide, such as MnO₂, CrO₃, OsO₄, RuO₄, or oxygen. In a particular embodiment, a step of controlling a reaction includes steps of maintaining pH of reaction solution below 7 (e.g., by adding additional acid during the reaction) and bubbling an oxidizing agent (e.g., oxygen) through said solution.

In another aspect, the present disclosure relates to a powder for use in making an electrode, where a powder includes a mixture of nanoparticles as disclosed herein and electrically conductive particles. In some embodiments, a mixture further comprises a binder and/or a mixture is homogenous.

These and other objects, along with advantages and features of disclosed systems and methods, will become apparent through reference to the following description and accompanying drawings. Furthermore, it is to be understood that features of various embodiments described are not mutually exclusive and can exist in various combinations and permutations.

### Definitions

In order for the present disclosure to be more readily understood, certain terms are first defined below. Additional definitions for the following terms and other terms are set forth throughout the specification.

In this application, unless otherwise clear from context, the term “a” may be understood to mean “at least one.” As used in this application, the term “or” may be understood to mean “and/or.” In this application, the terms “comprising” and “including” may be understood to encompass itemized components or steps whether presented by themselves or together with one or more additional components or steps. As used in this application, the term “comprise” and variations of the term, such as “comprising” and “comprises,” are not intended to exclude other additives, components, integers or steps.

About, Approximately: As used herein, the terms “about” and “approximately” are used as equivalents. Unless otherwise stated, the terms “about” and “approximately” may be understood to permit standard variation as would be understood by those of ordinary skill in the art. Where ranges are provided herein, endpoints are included. Any numerals used in this application with or without about/approximately are meant to cover any normal fluctuations appreciated by one of ordinary skill in the relevant art. In some embodiments, the term “approximately” or “about” refers to a range of values that fall within 25%, 20%, 19%, 18%, 17%, 16%, 15%, 14%, 13%, 12%, 11%, 10%, 9%, 8%, 7%, 6%, 5%, 4%, 3%, 2%, 1%, or less in either direction (greater than or less than) of the stated reference value unless otherwise stated or otherwise evident from the context (except where such number would exceed 100% of a possible value).

Electroactive Substance: As used herein, the term “electroactive substance” refers to a substance that changes its oxidation state, forms alloys, or partakes in a formation or breaking of chemical bonds, in a charge-transfer step of an electrochemical reaction.

Polymer: As used herein, the term “polymer” generally refers to a substance that has a molecular structure consisting chiefly or entirely of repeated sub-units bonded together, such as synthetic organic materials used as plastics and resins.

Nanostructure, Nanomaterial: As used herein, these terms may be used interchangeably to denote a composition with sub-micrometer features. Such materials can have essentially any shape or configuration, such as a tube, a wire, a laminate, sheets, lattices, a box, a core and shell, or combinations thereof.

Nanoparticle: As used herein, refers to a discrete particle with at least one dimension having sub-micron dimensions.

Substantially: As used herein, the term “substantially” refers to the qualitative condition of exhibiting total or near-total extent or degree of a characteristic or property of interest.

### BRIEF DESCRIPTION OF THE DRAWINGS

In the drawings, like reference characters generally refer to the same parts throughout the different views. Also, the drawings are not necessarily to scale, emphasis instead generally being placed upon illustrating principles of disclosed systems and methods and are not intended as limiting. For purposes of clarity, not every component may be labeled in every drawing. In the following description, various embodiments are described with reference to the following drawings, in which:

FIG. 1 is a pictorial representation of a nanoparticle in accordance with one or more embodiments of the present disclosure;

FIGS. 2A, 2B, and 2C are pictorial representations of alternative nanostructures in accordance with one or more embodiments of the present disclosure;

FIG. 3 is a pictorial representation of two states of a nanoparticle in accordance with one or more embodiments of the present disclosure;

FIGS. 4A and 4B are pictorial representations of a fabrication process for a core in accordance with one or more embodiments of the present disclosure;

FIG. 5 is a pictorial representation of an exemplary fabrication process for a nanostructure in accordance with one or more embodiments of the present disclosure;

FIG. 6 is a chemical representation of an exemplary synthesis process for a core comprising polythionate in accordance with one or more embodiments of the present disclosure;

FIG. 7 is a pictorial representation of a nanoparticle in accordance with one or more embodiments of the present disclosure;

FIG. 8 is a schematic representation of an exemplary electrochemical cell in accordance with one or more embodiments of the present disclosure;

FIG. 9 is a pictorial representation of a portion of an electrode made up of nanostructures in accordance with one or more embodiments of the present disclosure; and

FIG. 10 is a pictorial representation of an electrical storage device during a discharging cycle in accordance with one or more embodiments of the present disclosure.

### DETAILED DESCRIPTION

Generally, the present disclosure is directed to compositions (e.g., nanoparticles, powder mixtures, slurries) for use in energy storage devices and related methods for fabricating such compositions. In certain embodiments, a provided composition comprises a nanoparticle in the form of a core-shell structure with an electroactive core surrounded by a shell. In certain embodiments, a void space is interposed between core and shell. Without wishing to be bound by any particular theory, it is believed that void space reduces or eliminates mechanical stresses associated with volumetric expansion of an electroactive core during cycling of a battery. Methods described herein include forming an electroactive core and modifying the same. Provided nanoparticles are useful within energy storage devices, such as secondary batteries (e.g., a lithium-sulfur battery), a capacitor, or other electrochemical system.

I. Nanostructured Materials

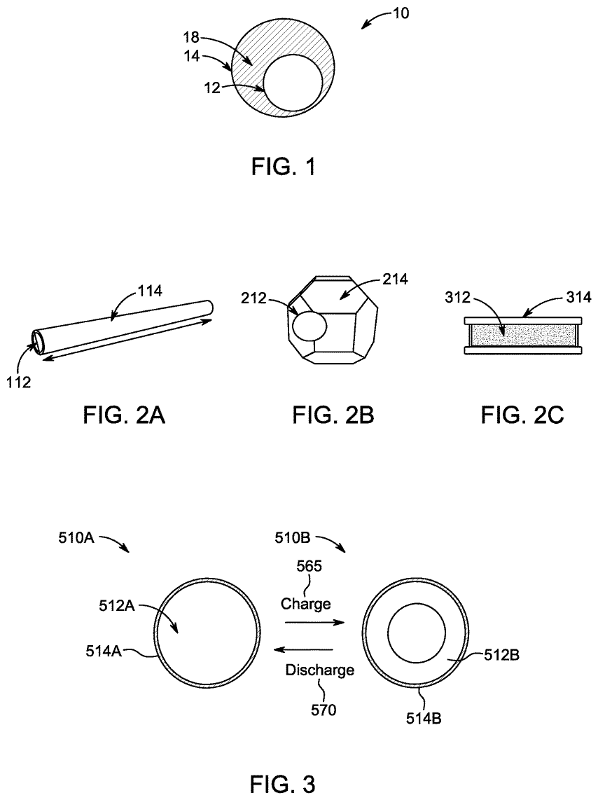

Nanostructured materials of the present disclosure are not limited to any specific morphology. Provided nanostructured materials may take various forms; a few non-limiting examples of which are illustrated in FIGS. 1 and 2A to 2C.

In the discussion below, while most explanations and examples pertain to core-shell nanoparticles, these are presented as non-limiting examples of a specific morphology in which provided polythionate compositions can be utilized to fabricate electrodes and electrochemical cells. Various alternative examples of provided compositions can include bulk powder mixtures, such as a ball-milled mixture of sulfur, Li₂S₂O₃, and carbon black, or slurries (e.g., various powder mixtures combined with one or more solvents) that can be used to produce electrodes.

In some embodiments, provided composites include a sulfur-based core (e.g., a core comprising lithium thiosulfate and sulfur or lithium sulfide) and a shell. Without wishing to be bound by any particular theory, it is believed that, in some embodiments, a provided sulfur-based core reacts electrochemically with metal ions during battery operation, e.g., to accept the metal ions to form a metal-sulfide during discharge of a battery and to release metal ions from a metal-sulfide during charging of the battery. In some embodiments, a shell at least partially encases a sulfur-based core and is formed from a material, such as a polymer, an inorganic material, elemental carbon, metal oxides, sulfides, or combinations thereof. As used herein, the term “polythionate” refers to a compound of formula SₓO₆²⁻, where x is ≥3. The term polythionate as used herein may also refer to compounds of formula SₓO₃⁻ (e.g. (S)ₙSO₃⁻). In certain embodiments, compositions of the present disclosure comprise equilibrium mixtures of SₓO₆²⁻ and SₓO₃⁻.

In certain embodiments, provided nanostructured materials are characterized in that an electroactive substance is in a form having nanometer dimensions. In certain embodiments, an electroactive substance is present in a form having at least one dimension with a length in a range of about 5 to about 1,000 nm. In certain embodiments, an electroactive substance is present in a form having at least one dimension with a length in a range of about 10 to about 50 nm, about 30 to about 100 nm, about 100 to about 500 nm, or about 500 to about 1,000 nm. In certain embodiments, an electroactive substance is present in a form having at least one dimension with a length in a range of about 5 to about 1,000 nm.

FIG. 1 depicts an example of a nanoparticle 10 manufactured in accordance with one or more embodiments of the present disclosure. Generally, the nanoparticle 10 is made up of a composite core 12 disposed within a shell 14, where the shell 14 also defines an internal cavity 18 (or void space).

Typically, electroactive cores for lithium-sulfur batteries are made of a sulfur material, such as elemental sulfur, S₈, metal sulfides, sulfur-containing polymers, or organic molecules. Shells of conventional nanoparticle shells are made of an organic polymer material, such as polyaniline or other organic polymers capable of providing a shell to facilitate lithium ion transport and sulfur material vapor transport as required during operation; however, other shell materials as previously disclosed are contemplated and considered within the scope of the present disclosure.

Generally, dimensions and shape of provided compositions (e.g., a nanoparticle) will vary to suit a particular application. In some embodiments, a nanoparticle has a dimension (e.g., diameter or length) in a range of about 20 nm to about 1,000 nm, with a wall thickness in a range of about 5 nm to about 50 nm. In certain embodiments, core size and shape is varied to suit a particular application and, in some instances, has a dimension in a range of about 200 nm to about 300 nm. Generally, a core will take up about 20% to about 80% of a volume of an internal cavity 18, depending on charge/discharge status of an electrode or energy storage device containing provided nanoparticles.

Alternative nanoparticles, or nanostructures, 100, 200, 300 are depicted in FIGS. 2A to 2C. As shown in FIG. 2A, and similar to depicted nanoparticle of FIG. 1, nanoparticle 100 includes a sulfur-based core 112 surrounded by a shell 114; however, nanoparticle 100 is in the form of a nanowire or nanotube. FIG. 2B depicts a nanoparticle 200 comprising a sulfur-based core 212 surrounded by a shell 214. In certain embodiments, in accordance with FIG. 2B, a nanostructured material comprises a complex structure containing one or more arcuate and/or polygonal shapes. Provided nanostructured material of FIG. 2C comprises a layered structure containing one or more layers of an electroactive substance(s) (i.e., a sulfur-based core 312) alternating with one or more shell layers.

FIG. 3 illustrates two states of a core-shell nanoparticle 510, in accordance with one embodiment of the present disclosure. Generally, a core-shell nanoparticle, in an initial synthesized state (510A) includes a lithium sulfide-based nanoparticle core 512A. Nanoparticle core 512A may have a spherical shape as shown; however, a provided core may alternatively have other shapes, such as ovals, crystals, wires, columns, boxes, and so forth.

As previously discussed, a nanoparticle has a thin shell 514 that retains metal sulfide, polysulfide, and polythionate materials within nanoparticle core 512A. Thus, shell 514 prevents migration of polysulfides (and therefore sulfur) out of a core-shell nanoparticle. In some embodiments, a shell 514 has a thickness of approximately 1-10 nm and makes up about 5-10% of a core-shell nanoparticle by weight. Typically, a shell 514 will be electrically and/or ionically conductive to enable electrons and/or ions to pass into and out of a nanoparticle core 512A.

When a core-shell nanoparticle 510 is used in a Li/S cell, provided Li/S cell may be charged 565, which causes lithium atoms to be extracted from its core-shell nanoparticle and migrated to a negative electrode. While a Li/S cell is charged, its core-shell nanoparticle has a charged state (510B). In a charged state, a core of a core-shell nanoparticle is a sulfur-based nanoparticle core 512B. In some embodiments, a sulfur nanoparticle core 512B occupies a volume that is smaller than a volume occupied by lithium sulfide-based nanoparticle core 512A. In some embodiments, shell 514 has sufficient structural strength or elasticity to accommodate a volume change that occurs during a charge/discharge process.

A Li/S cell may be discharged 570, which causes lithium atoms to migrate back into core-shell nanoparticle 510A. This causes a core of a core-shell nanoparticle to return to a lithium sulfide-based nanoparticle core 512A. In a transition from a sulfur-based nanoparticle core 512B to a lithium sulfide-based nanoparticle core 512A, a core grows back to approximately its original size and composition.

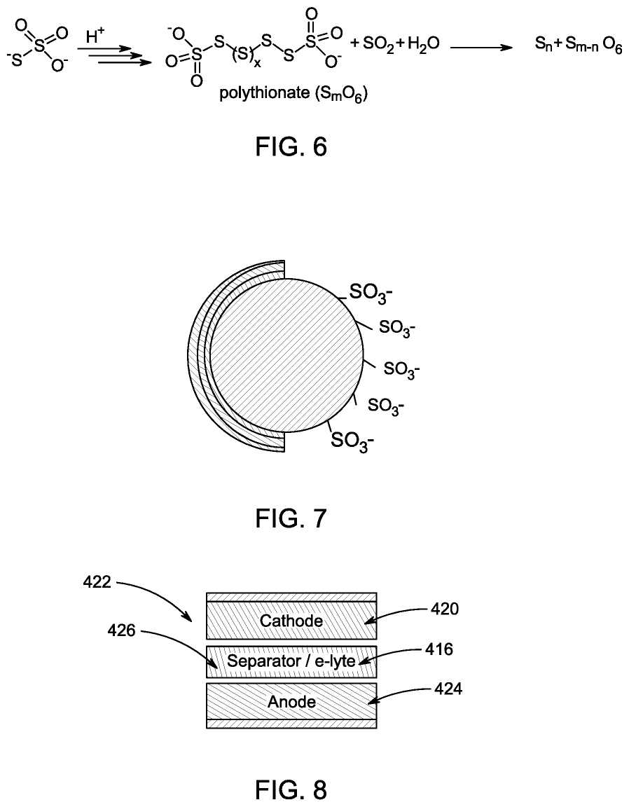

FIG. 6 depicts an exemplary formation of a sulfur-based core where polythionates are an initially formed product during sulfur synthesis from thiosulfate. Generally, a polythionate is a conjugate base of a polythionic acid (e.g., an oxoacid), such as dithonic acid, trithionic acid, tetrathionic acid, pentathionic acid, etc. Formation of elemental sulfur from polythionates is a complex process, whose rate can vary widely depending on reaction conditions. Examples of such a process are disclosed below. Generally, during synthesis in water, long-chain polythionates organize into micelles with hydrophilic anionic surfaces and hydrophobic interiors that contain sulfur chains of thionates and elemental sulfur. See FIG. 7.

Inclusion of polythionates in an improved core allows a nanoparticle to be “tuned” to impact performance. A challenge in developing sulfur cathodes is that their capacity fades over multiple cycles. Without being bound to any particular theory, it is believed that observed loss of capacity is at least partially due to sulfur becoming physically and electrochemically inaccessible during cycling. Given that sulfur batteries are conversion cathodes, (e.g., cathodes whose operation requires repeated consumption and reforming of new chemical compounds), and the fact that end-members of multistep redox reaction of sulfur (S₈ and Li₂S) are both insoluble and highly electrically insulating, it is critical that deposition of these compounds be controlled to avoid depositing sulfur or Li₂S in forms or locations where it will not be in good contact with electrical or lithium ion conducting substances. Such materials become stranded and are lost to further conversion causing capacity fade. Without being bound by theory, or thereby limiting the scope of the present disclosure, it is believed that presence of thionate groups in a sulfur cathode prevents these undesirable phenomena by modulating dynamics of sulfur consumption and re-deposition in the cathode, thereby providing sulfur cathodes that suffer less capacity fade over time. This effect varies as ratio of thionate functional groups to elemental sulfur atoms in a particles varies. In some embodiments, a mass ratio of —SO₃⁻ functional groups to S⁰ atoms (e.g., atoms in Sₙ) in a core is at least about 1:200 and may be as high as about 1:5. Since content of elemental sulfur atoms (S⁰) will vary as an energy storage device cycles through discharge and charge cycles and since an electroactive elemental sulfur may be partially or wholly reduced to S²⁻ during cycling, in certain embodiments herein a thionate to sulfur ratios described refer to a ratio of —SO₃⁻ groups to a sum of S⁰ and S²⁻ atoms present. For example, as a device discharges and cathodic sulfur reduces to Li₂S or other reduced species. During a charge cycle, a core reforms returning to substantially the same ratio of —SO₃⁻ functional groups to S⁰ atoms, though specific chemical atoms may be different before and after a cycle.

### Electroactive Core Compositions

Nanostructured materials of the present disclosure comprise an electroactive substance. An electroactive substance is preferably in a form having nanometer dimensions. In certain embodiments, an electroactive substance is present in a form having at least one dimension with a length in a range of about 5 to about 1,000 nm. In certain embodiments, the electroactive substance is present in a form having at least one dimension with a length in a range of about 10 to about 50 nm, about 30 to about 100 nm, about 100 to about 500 nm, or about 500 to about 1,000 nm. In certain embodiments, an electroactive substance is present in a form having at least one dimension with a length in a range of about 400 to about 1,000 nm.

In certain embodiments, provided nanostructured materials have utility as cathode materials for sulfur batteries. Such compositions necessarily comprise an electroactive sulfur-based material. Examples of suitable electroactive sulfur materials include elemental sulfur, sulfur-containing organic molecules, polymers or composites, or metal sulfides as well as combinations or composites of two or more of these.

In certain embodiments, electroactive sulfur is present in the form of elemental sulfur. In certain embodiments, electroactive sulfur material comprises S₈.

In certain embodiments, electroactive sulfur is present as a metal sulfide. In certain embodiments, a metal sulfide comprises an alkali metal sulfide; in certain embodiments, a metal sulfide comprises lithium sulfide.

In certain embodiments, electroactive sulfur material is present as a composite with another material. Such composites may include conductive additives such as graphite, graphene, metal sulfides or oxides, or conductive polymers. In certain embodiments, sulfur may be alloyed with other chalcogenides such as selenium or arsenic.

Generally, dimensions and shape of electroactive sulfur-based material in a provided cathode composition may be varied to suit a particular application and/or be controlled as a result of nanostructure morphology. In various embodiments, electroactive sulfur-based material is present as a nanoparticle. In certain embodiments, such electroactive sulfur-based nanoparticles have a spherical or spheroid shape. In certain embodiments, nanostructured materials of the present disclosure comprise substantially spherical sulfur-containing particles with a diameter in a range of about 50 to about 1,200 nm. In certain embodiments, such particles have a diameter in a range of about 50 to about 250 nm, about 100 to about 500 nm, about 200 to about 600 nm, about 400 to about 800 nm or about 500 to about 1,000 nm.

Such nanoparticles may have various morphologies as described above. In certain embodiments, electroactive sulfur-based material is present as a core of a core-shell particle, where it is surrounded by a conductive shell. In certain embodiments, such core-shell particles may comprise yolk-shell particles as described above.

II. Cathode Mixtures

Generally, various nanostructures disclosed herein can be used to produce cathodes. Cathode production typically involves applying a uniform layer of a cathode mixture onto a current conductor such a metal foil or conductive carbon sheet. In certain embodiments, the present disclosure provides cathode mixtures that are useful for producing and manufacturing cathodes for batteries or other electrochemical devices. Provided cathode mixtures include nanostructured materials according to embodiments and examples herein (e.g., nanowires, core-shell particles, etc.) optionally mixed with additional materials such as electrically conductive additives, binders, surfactants, stabilizers, wetting agents and the like. Such mixtures are typically provided in the form of fine powders that can be applied by techniques such as slurry coating or roll-to-roll processing. Cathode mixtures typically comprise relatively larger quantities of materials than materials made for experimental evaluation and it can be non-trivial to produce nanostructured materials with consistent characteristics in large batches. In certain embodiments, cathode mixtures of the present disclosure are characterized in that they comprise a homogenous sample with a quantity greater than about 100 grams (g), greater than about 1 kilogram (kg), greater than about 10 kg, greater than about 100 kg, or greater than about 1 ton.

In various embodiments, additional materials may be included with nanostructured materials to alter or otherwise enhance provided cathode mixtures produced from a mixture. Generally, provided cathode mixtures will contain nanoparticles in a proportion ranging from about 50 wt. % to about 98 wt. %, preferably about 60 wt. % to about 95 wt. %, and more preferably about 75 wt. % to about 95 wt. % of a total cathode mixture.

In certain embodiments, cathode mixtures comprising provided nanoparticles contain at least 50 wt. % sulfur relative to all components in a cathode mixture. In certain embodiments, provided cathode mixtures are characterized in that they have a high sulfur content. In certain embodiments, provided cathode mixtures are characterized in that they contain above about 75 wt. %, above about 80 wt. %, above about 85 wt. %, or above about 90 wt. % sulfur relative to total cathode mixture.

In certain embodiments, provided nanostructured materials are mixed with electrically conductive particles (e.g., conductive carbon, such as carbon black, graphene, etc.) and a binder. Typical binders include polyvinylidene fluoride (PVDF), polyethylene oxide (PEO), polyethylene (PE), polypropylene (PP), polytetrafluoroethylene (PTFE), polyacrylates, polyvinyl pyrrolidone, (PVP) poly(methyl methacrylate) (PMMA), copolymers of polyhexafluoropropylene and polyvinylidene fluoride, polyethyl acrylate, polyvinyl chloride (PVC), polyacrylonitrile (PAN), polycaprolactam, polyethylene terephthalate (PET), polybutadiene, polyisoprene or polyacrylic acid, or derivatives blends or copolymers thereof. In some embodiments, a binder is water soluble binder, such as sodium alginate, or carageenan. Generally, binders hold active materials together and in intimate contact with a current collector (e.g., aluminum foil or copper foil, carbon paper or fabric).

In certain embodiments, cathode powder mixtures can be provided without a binder, which can be added during a manufacturing process to produce electrodes (e.g., as a solution or dispersion in water or a suitable carrier).

In various embodiments, a cathode mixture is ground, powdered or mixed to control properties of a cathode powder mixture (e.g. particle size) and to thoroughly mix ingredients. Such mixing can be performed by any means known in the art including but not limited to pin milling, hammer milling, jet milling, ball milling, air classifying, and combinations of these. Specific means used for mixing a cathode powder mixture will vary to suit a particular application, such as large scale production of cathode mixtures (e.g., production of drum quantities of powder for sale to cathode manufacturers).

Various materials for use in cathode mixtures are disclosed in Cathode Materials for Lithium Sulfur Batteries: Design, Synthesis, and Electrochemical Performance, Lianfeng, et al., Interchopen.com, Published June 1st 2016 and The strategies of advanced cathode composites for lithium-sulfur batteries, Zhou et al., SCIENCE CHINA Technological Sciences, Volume 60, Issue 2: 175-185(2017), the entire disclosures of which are hereby incorporated by reference herein.

III. Electrode Compositions

There are a variety of methods for manufacturing electrodes for use in a LiS battery. One such process, referred to as a “wet process,” involves adding a positive active material (i.e., the nanostructured materials), a binder and a conducting material (i.e., the cathode mixture) to a liquid to prepare a slurry. Compositions are typically formulated into a viscous slurry in order to facilitate a downstream coating operation. A thorough mixing of a slurry can be critical for coating and drying operations, which will eventually effect performance and quality of electrodes. Appropriate slurry mixing devices include ball mills, magnetic stirrers, sonication, planetary mixers, high speed mixers, homogenizers, universal type mixers, and static mixers. In certain embodiments, a liquid is any liquid that effectively disperses positive active material, binder, conducting material, and any additives homogeneously, and is easily evaporated. Possible slurrying liquids include, for example, N-methylpyrrolidone, acetonitrile, methanol, ethanol, propanol, butanol, tetrahydrofuran, water, isopropyl alcohol, dimethylacetamide and the like.

In certain embodiments, a prepared composition is coated on a current collector and dried to form a positive electrode. Specifically, a slurry is used to coat an electrical conductor to form an electrode by evenly spreading a slurry on to a conductor, which may then optionally be roll-pressed, calendared, and heated as is known in the art. Generally, a dried slurry forms a matrix held together and adhered to a conductor by a polymeric binder included in a cathode mixture. In certain embodiments, a matrix comprises a lithium conducting polymer binder, such as polyvinylidene difluoride (PVDF), styrene butadiene rubber (SBR), polyethylene oxide (PEO), polyacrylic acid, polyacrylates, carageenan, and polytetrafluoroethylene (PTFE). In some embodiments, additional carbon particles, carbon nanofibers, carbon nanotubes, etc. are dispersed in a matrix to improve electrical conductivity. In some embodiments, lithium salts are dispersed in a matrix to improve lithium conductivity.

In certain embodiments, a current collector is any suitable material with good electronic conductivity. In certain embodiments, the current collector is selected from the group consisting of: aluminum foil, copper foil, nickel foil, stainless steel foil, titanium foil, zirconium foil, molybdenum foil, nickel foam, copper foam, conductive carbon papers, sheets, or fabrics, polymer substrates coated with conductive metal, and/or combinations thereof.

In certain embodiments, thickness of a matrix may range from a few microns to hundreds of microns (e.g., 2-200 microns). In some embodiments, a matrix has a thickness of about 10 to about 50 microns. Generally, increasing thickness of a matrix increases percentage of active materials relative to other cell constituents by weight, and may increase cell capacity. However, diminishing returns may be exhibited beyond certain thicknesses. In some embodiments, a matrix has a thickness of between about 5 and about 200 microns. In some embodiments, a matrix has a thickness of between about 10 and about 100 microns.

A negative electrode (i.e., anode) contains a negative active material. In some embodiments, a negative active material is one that can reversibly release lithium ions. In some embodiments, a negative active material may be lithium metal or a lithium composite with other materials such as carbon, tin, titanium, silicon, and mixtures, alloys, or composites of any of these. Suitable carbon materials include crystalline carbon, amorphous carbon, graphitic carbon, graphene, carbon nanotubes, or a combination thereof. Other suitable materials, which can reversibly form a lithium-containing compound by reacting with lithium or its ions, may include tin oxide (SnO₂), titanium nitrate, silicon (Si), and the like, but not limited thereto. Lithium metal may be present in pure form or alloyed. Lithium alloys may include lithium and metal selected from the group consisting of: Na, K, Rb, Cs, Fr, Be, Mg, Ca, Sr, Ba, Zn, Al and Sn. Typically, a negative electrode may also contain negative active material disposed on a current collector, such as those described above.

PCT Publication Nos. WO2015/003184, WO2014/074150, and WO2013/040067, the entire disclosures of which are hereby incorporated by reference herein, described various methods of fabricating electrodes and electrochemical cells that are suitable to utilize nanostructured materials of the present invention.

IV. Electrochemical Cells

Generally, an electrochemical battery such as an Li/S battery comprises a stack of electrodes comprising a plurality of individual electrochemical cells. FIG. 8 shows a representative electrochemical cell 422 that can be used in an Li/S battery. Cell 422 is formed with a positive electrode (cathode 420), a negative electrode (anode 424), a separator 426 disposed between the anode 424 and the cathode 420, and an electrolyte 416. An electrolyte may be a solid, a liquid, or a gel electrolyte. In certain embodiments, where a liquid electrolyte is used, it is, in some instances, held in pores of a porous separator 426, as well as in pores in cathode 420 and anode 424 if these are porous structures. These cells 422 can be used for a variety of batteries or other electrochemical energy storage devices. Electrochemical cells disclosed herein, in some embodiments, are substituted in place of, or used in conjunction with, conventional electrodes for lithium-sulfur batteries or other types of batteries. Number of cells 422 and their specific configurations can vary to suit a particular application. Operation of an electrochemical cell is described below with respect to FIG. 10.

V. Methods

In various embodiments, a core is manufactured in a fully charged state, as opposed to a conventional discharged state. However, a core can be made in a partially charged state as well to suit a particular application.

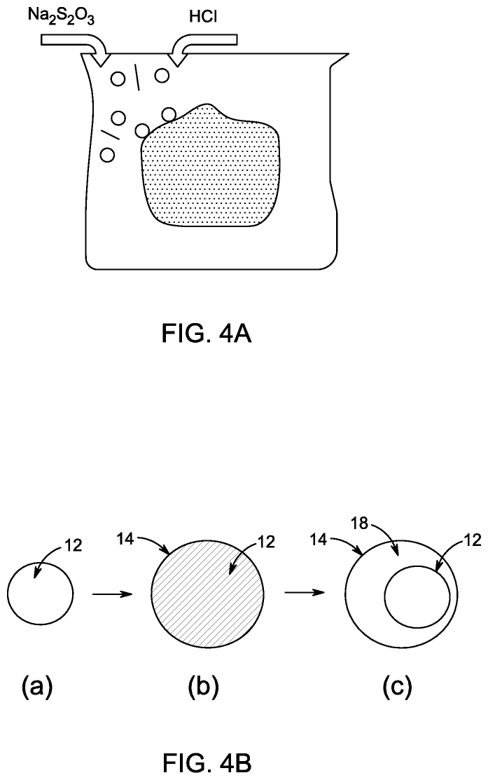

FIGS. 4A and 4B depict a basic manufacturing process for creating a core for a nanoparticle in accordance with one or more embodiments of the present disclosure. Generally, a sulfur-based particle is prepared via reaction of, for example, sodium thiosulfate with an acid (e.g., hydrochloric, formic, or sulfuric) in the presence of a surfactant (e.g. 1 wt. % polyvinylpyrrolidone (PVP, Mw about 40,000)).

FIG. 4B depicts various stages of a general approach to manufacturing a nanoparticle, modifications of such a process has utility for making compositions according to one or more embodiments of the invention. As shown at (a), a sulfur-based particle is prepared via an above-referenced reaction. Freshly prepared sulfur particle(s) is then dispersed in an aqueous solution of aniline and diluted sulfuric acid under strong stirring to obtain a sulfur particle or core 12 surrounded by a polyaniline shell 14, as shown at (b).

After particle 10 has been produced with core 12 encapsulated by a polyaniline shell (b), core 12 can be partially removed (e.g. by vacuum or dissolution) to separate core 12 from shell 14 and define a void space 18 therein. In some embodiments, an interim coated nanoparticle 10 as shown in (c) is obtained through oxidation with ammonium persulphate at 0° C. for 24 h. As previously described, in some embodiments, a shell is formed by materials other than polymers.

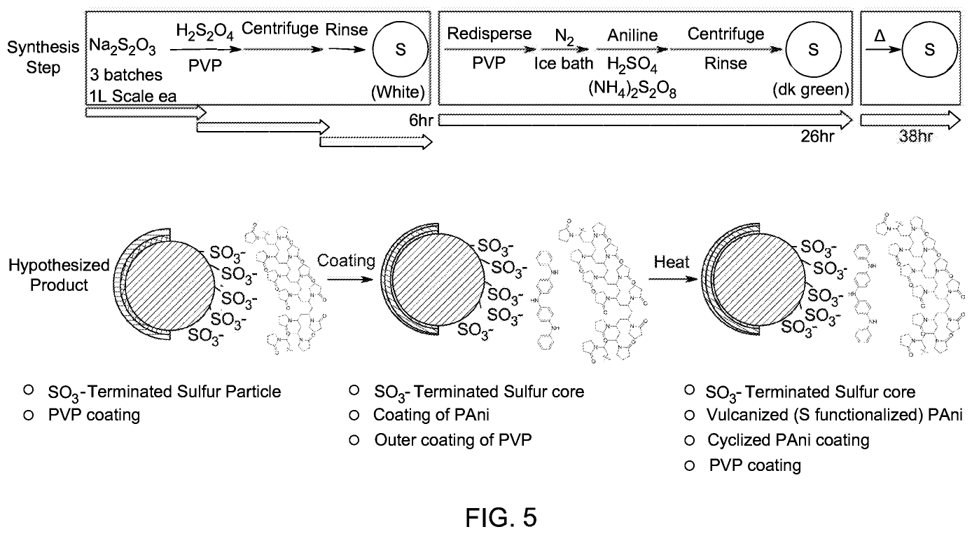

FIG. 5 depicts a process for fabricating a particular nanoparticle. Generally, a shell functions to retain polysulfides within a nanoparticle shell and afford high electrical conductivity. As shown at (a), a hypothetical particle is synthesized, where a particle has a sulfur-based core comprising polythionates and a PVP coating. In some embodiments, a particle is than encapsulated in a polyaniline shell and an additional PVP coating (b) before being vulcanized (c), or otherwise processed to form a finished particle.

In alternative embodiments, sulfur-based cores can be produced in a bulk state and may be mechanically milled (e.g., ball milled) to reduce particle sizes down to nanoscale particles. Such mechanical milling should be performed under a neutral (inert) gas atmosphere. Other examples of basic methods for forming nanoparticle cores are described in PCT publication number WO2014/074150, the entire disclosure of which is hereby incorporated by reference herein.

In certain embodiments, an electroactive sulfur composition is produced by milling elemental sulfur in the presence of polythionate or thiosulfate salts to provide a composition with a controlled ratio of S⁰ atoms to —SO₃⁻ groups. In certain embodiments, a sulfur based core is produced by mechanically milling elemental sulfur with lithium polythionate. In certain embodiments, a sulfur based core is produced by mechanically milling elemental sulfur with lithium thiosulfate. In certain embodiments a ratio of elemental sulfur to thionate or thiosulfate salt is controlled such that a ratio of S⁰ atoms to —SO₃⁻ groups in a composition is between about 4:1 and about 500:1. In certain embodiments this ratio is between about 10:1 and about 50:1, between about 20:1 and about 100:1, or between about 50:1 and about 200:1.

In certain embodiments, an electroactive sulfur composition is produced by milling lithium sulfide or lithium polysulfides with polythionate or thiosulfate salts to provide a composition with a controlled ratio of S² atoms to —SO₃⁻ groups. In certain embodiments, a sulfur based core is produced by mechanically milling lithium sulfide with lithium polythionate. In certain embodiments, a sulfur based core is produced by mechanically milling lithium sulfide with lithium thiosulfate. In certain embodiments a ratio of lithium sulfide to thionate or thiosulfate salt is controlled such that a ratio of S² atoms to —SO₃⁻ groups in a composition is between about 4:1 and about 500:1. In certain embodiments this ratio is between about 10:1 and about 50:1, between about 20:1 and about 100:1, or between about 50:1 and about 200:1.

Typically, freshly prepared sulfur-based particle(s) is subjected to further processes to encapsulate a core within a shell and produce a finished nanoparticle. In some embodiments, sub-micron sulfur-based particles are generated in-situ from reaction of sodium thiosulfate with hydrochloric acid in the presence of specific polymers that encapsulate formed sulfur particles. Sulfur generating reaction shown in FIG. 4A is conducted in the presence of polymers that contain hydrophobic and hydrophilic domains. Polymer structure governs growth of hydrophobic sulfur near hydrophobic domains. The polymer backbone rearranges in hydrophilic medium (e.g., an aqueous solution) to form enclosed structures such as spheres/cubes, rhomboids, etc. that encapsulate a sulfur-based core.

As discussed above, a sulfur-based particle can be prepared via reaction of a thiosulfate salt (e.g. lithium, sodium, or potassium thiosulfate) with an acid; however, it is also possible to prepare a sulfur-based particle via reaction of SO₂ or a sulfite salt (e.g. Na₂SO₃, K₂SO₃, CaSO₃, Li₂SO₃, or MgSO₃) with hydrogen sulfide in water. Alternatively, a sulfur-based particle can be prepared by pouring a solution of elemental sulfur Sₙ dissolved in an organic solvent (e.g. carbon disulfide, benzene, toluene, fluorobenzene, etc.) into an aqueous solution to facilitate precipitation. In some embodiments, an aqueous solution contains one or more salts. In some such embodiments, an aqueous solution further contains an oxidizing agent for in situ oxidation of a sulfur-based particle as it forms or a precipitated sulfur-based particle may be subsequently oxidized via reaction with an oxidizing agent to generate —SO₃⁻ groups in a sulfur-based particle. In certain embodiments, such oxidizing steps result in formation of polythionates within the particle.

In various embodiments, synthetic parameters are modulated to tune a polythionate to elemental sulfur ratio of a sulfur-based particle to achieve a preferred composition. For example, in some embodiments, an oxidizing agent is present in a reaction mixture.

A selected oxidizing agent can be a salt, such as, a peroxymonosulfate [HSO₅]⁻, a permanganate [MnO₄]⁻, a dichromate [Cr₂O₇]²⁻, a chromate [CrO₄]⁻, a bromate salt [BrO₃]⁻, a hypochlorite salt [ClO]⁻, a chlorate [ClO₃]⁻, a perchlorate [ClO₄]⁻, a periodate [IO₄]⁻, or a nitrate [NO₃]⁻, where the counter cation is selected from the group consisting of Li⁺, Na⁺, K⁺, Ag⁺, Mg²⁺, or Ca²⁺. In some embodiments, an oxidizing agent is a metal oxide, such as MnO₂, CrO₃, OsO₄, RuO₄, or Fe₂O₃. In some embodiments, hydrogen peroxide or an organic peroxide or peroxy-acid is used as an oxidant. In some embodiments, oxygen gas and/or ozone is added as an oxidizing agent (e.g., bubbled through a solution).

In certain embodiments, pH of a reaction is preferably about 7 or less. In some embodiments, pH is modulated via addition of acid to be in a range of about 3 to 7, or about 4 to 6.

In some embodiments, particles are stirred at room temperature. In some embodiments, particles are stirred at low temperature, such as in an ice bath. In some embodiments, heat is applied (e.g., about 30° C., about 40° C., about 50° C., about 60° C., about 70° C., or about 80° C.).

In some embodiments, a reaction mixture is exposed to ultraviolet (UV) radiation. In some embodiments, a reaction mixture is stirred in the dark. In some embodiments, a reaction mixture is stirred in ambient light. Generally, percentage of polythionates present in a finished sulfur-based particle can be varied by varying conditions under which such particle is formed, for example, exposure UV radiation accelerates aging of a particle. In addition to conditions identified above, a reaction can be controlled by adding a surfactant, varying a mixing protocol (e.g., continuous or intermittent stirring), or washing of particles.

In some embodiments, sulfur-based particles are isolated by precipitation. In some embodiments, control of polythionate to elemental sulfur ratio of sulfur-based particles is afforded via precipitation of a composite after stirring for various lengths of time, such as within about 1 to about 3 hour (h), about 2 to about 7 h, about 5 to about 12 h, about 10 to about 20 h, about 16 to about 24 h, about 24 to about 48 h, or about 48 to about 192 h.

In some embodiments, a sulfur-based core is aged post-synthesis by treatment with a solvent that preferentially dissolves sulfur but not polythionate. Suitable solvents for such processes include, but are not limited to cyclohexane, CS₂, benzene, toluene, etc. and mixtures containing any of these. In some embodiments, a process can comprise a step of contacting a sulfur-based core with such solvent for a proscribed period; for example about 1 to about 3 h, about 2 to about 7 h, about 5 to about 12 h, about 10 to about 20 h, about 16 to about 24 h, about 24 to about 48 h, or about 48 to about 192 h. In certain embodiments, a solution is stirred at room temperature. In some embodiments, temperature of a contacting step is controlled—for example a process can be conducted at elevated temperatures, for example a temperature of about 30° C., about 40° C., about 50° C., about 60° C., about 70° C., or about 80° C.

Generally, a reaction is controlled or a post-processing of a particle(s) is carried out to obtain a core where polythionate is increased up to about 25 wt. % of the core, up to about 20 wt. %, up to about 15 wt. %, or up to about 10 wt. %. By controlling a reaction, it is possible to increase wt. % of polythionate that forms or is retained within a core. In some embodiments, for example, where too much polythionate is present, it is possible to reduce total amount of polythionate by aging a sulfur-based particle. In some embodiments, composition of a core can be measured via, for example, high-pressure liquid chromatography (HPLC), ion chromatography (IC), combustion analysis or by thermogravimetric analysis (TGA). Other means of determining composition of a core are disclosed in The Molecular Composition of Hydrophillic Sulfur Sols Prepared by Acid Decomposition of Thiosulfate, Steudel et al, Z. Naturforsch 43b, 203-218 (1988), the entire disclosure of which is incorporated by reference herein.

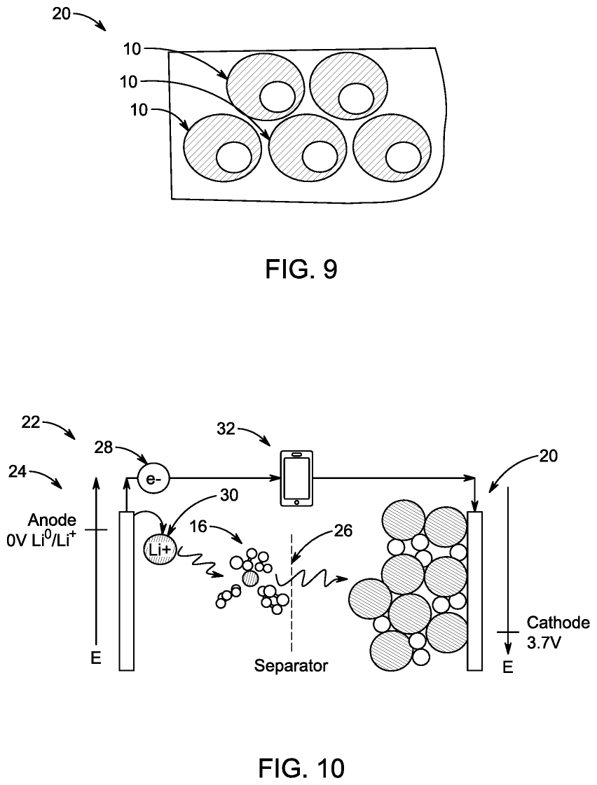

FIG. 9 depicts one possible arrangement of nanoparticles to create an electrode 20, such as a cathode. Generally, the cathode 20 is made up of a plurality of nanoparticles 10 that may take the form of sheets or foils, wires, or other agglomerations of encapsulated structures combined with one or more suitable binders (see, for example, FIGS. 2A-2C).

FIG. 10 depicts one possible electro-chemical cell 22 that can be used to manufacture a battery in accordance with one or more embodiments of the present disclosure. Cell 22 is depicted during a discharge operation. Cell 22 includes an anode 24 made up of a lithium-based material, a cathode 20 made up of nanoparticles disclosed herein, a separator 26, and an electrolyte 16. During discharge operation, lithium-based material of anode 24 (a high potential energy state) is oxidized, generating an electron 28 and a lithium ion 30. Electron 28 performs work in an external circuit 32, while lithium ion 30 passes through separator 26 and recombines with electron 28 in cathode 20 (a lower potential energy state). Electrolyte 16 acts as a medium for lithium ions 30 to move within the cell and to passivate a reactive anode surface (the “Solid Electrolyte Interphase” (SEI)). It should be noted that instability of electrolyte 16 and SEI can lead to cell performance degradation.

During charging, specifically recharging, lithium ions 30 move back through electrolyte 16 towards anode 24, and electrons 28 travel back through external circuit 32. Typically, lithium ions 30 react with any degradation products (e.g., cathode active materials that have dissolved into electrolyte, such as polysulfides) in electrolyte 16 forming insoluble solids that lead to anode and cathode fouling and reduced capacity and slower charging. Using nanoparticles described herein helps to retain sulfur in a cathode to reduce or eliminate formation of polysulfides in electrolyte 16. Without wishing to be bound by any particular theory, it is believed that this is due, at least in part, to the fact that polythionates do not degrade.

It is contemplated that compositions of matter and processes of present application encompass variations and adaptations developed using information from embodiments described in the present disclosure. Adaptation or modification of methods and processes described in this specification may be performed by those of ordinary skill in the relevant art.

Throughout the description, where compositions, compounds, or products are described as having, including, or comprising specific components, or where processes and methods are described as having, including, or comprising specific steps, it is contemplated that, additionally, there are articles, devices, and systems of the present application that consist essentially of, or consist of, the recited components, and that there are processes and methods according to the present application that consist essentially of, or consist of, the recited processing steps.

It should be understood that order of steps or order for performing certain action is immaterial so long as a described method remains operable. Moreover, two or more steps or actions may be conducted simultaneously.

What is claimed:

1. A core-shell nanoparticle comprising:
a shell defining an internal volume; and
a sulfur-based core with a composition different from the shell and disposed within the internal volume defined by the shell;
wherein the core comprises polythionate.

2. The core-shell nanoparticle of claim 1, wherein the sulfur-based core comprises a polythionate composition comprising a plurality of molecules of formula ⁻O₃S—(S)ₙ—SO₃⁻, wherein n is on average in the composition between about 1 and about 40.

3. The core-shell nanoparticle of claim 1, wherein the sulfur-based core further comprises elemental sulfur.

4. The core-shell nanoparticle of claim 3, wherein a mass ratio of elemental sulfur to polythionate in the sulfur-based core is between about 1:10 and about 10:1.

5. The core-shell nanoparticle of claim 4, wherein a molar ratio of —SO₃⁻ functional groups to S⁰ atoms in the core is at least 1:200.

6. The core-shell nanoparticle of claim 1, further comprising lithium.

7. The core-shell nanoparticle of claim 6, wherein the core comprises lithium polythionate.

8. The core-shell nanoparticle of any one of the preceding claims, wherein the polythionates comprise less than about 25 wt. % of the core, less than about 20 wt. %, less than about 15 wt. %, or less than about 10 wt. %.

9. The core-shell nanoparticle of any one of the preceding claims, wherein the polythionates comprise about 1 to about 10 wt. % of the core.

10. The core-shell nanoparticle of any one of the preceding claims, wherein the core further comprises one or more conductive additives.

11. The core-shell nanoparticle of claim 10, wherein the sulfur-based core comprises a composite of elemental sulfur, polythionate, and a conductive additive.

12. The core-shell nanoparticle of any one of the preceding claims, wherein the shell comprises a polymer.

13. The core-shell nanoparticle of claim 12, wherein the shell comprises a conductive polymer.

14. The core-shell nanoparticle of any one of the preceding claims, wherein the shell comprises an inorganic material.

15. The core-shell nanoparticle of claim 14, wherein the shell comprises a transition metal oxide.

16. The core-shell nanoparticle of claim 14, wherein the shell comprises a transition metal sulfide.

17. The core-shell nanoparticle of any one of the preceding claims, wherein the shell comprises a composite of one or more polymers with at least one conductive additive.

18. The core-shell nanoparticle of any one of the preceding claims, wherein a dimension of the nanoparticle is between about 20 and about 1,000 nm.

19. The core-shell nanoparticle of claim 18, wherein the nanoparticle is substantially spherical.

20. The core-shell nanoparticle of claim 18, wherein the nanoparticle is a nanowire.

21. The core-shell nanoparticle of claim 18, wherein the nanoparticle is a plate.

22. The core-shell nanoparticle of any one of the preceding claims, wherein the sulfur-based core occupies only a portion of the internal volume defined by the shell.

23. The core-shell nanoparticle of claim 22, wherein the sulfur-based core occupies between about 20% and about 80% of the internal volume defined by the shell.

24. The core-shell nanoparticle of any one of the preceding claims, wherein the shell has a thickness of between about 5 and about 50 nm.

25. The core-shell nanoparticle of any one of the preceding claims, wherein the shell comprises two or more layers.

26. The core-shell nanoparticle of claim 25, wherein two or more of the layers have different compositions.

27. The core-shell nanoparticle of claim 26, wherein at least one layer is a polymer and at least one layer comprises elemental carbon or an inorganic composition.

28. A core-shell nanoparticle comprising:
a shell defining an internal volume; and
a core comprising a composite of lithium thiosulfate and lithium sulfide disposed within the internal volume defined by the shell.

29. An electrode for an energy storage device, the electrode comprising:
a core-shell nanoparticle comprising:
a shell defining an internal volume; and
a sulfur-based core with a composition different from the shell and disposed within the internal volume defined by the shell;
wherein the sulfur-based core comprises polythionate.

30. An energy storage device comprising:
an anode;
a cathode comprising:
a core shell nanoparticle comprising a shell defining an internal volume; and
a sulfur-based core comprising polythionate disposed within the internal volume defined by the shell;
a separator; and
an electrolyte.

31. A battery comprising:
an anode;
a cathode comprising lithium polythionate;
a separator; and
an electrolyte.

32. An electrode for an electrochemical energy storage device, the electrode comprising a nanoparticle in accordance with any one of claims 1-28.

33. An electrochemical energy storage device comprising:
an anode;
a cathode comprising:
a plurality of nanoparticles in accordance with any one of claims 1-28;
a separator; and
an electrolyte.

34. A method of producing a sulfur-based core comprising polythionate for a core-shell nanoparticle, the method comprising the steps of:
introducing sodium thiosulfate to an acid solution;
reacting the sodium thiosulfate in the acid solution to precipitate a sulfur-based core material; and
controlling the reaction by at least one of introducing an oxidizing agent to the acid solution, adjusting a pH of the acid solution, varying an environmental condition, adding a surfactant to the acid solution, varying a mixing protocol, or washing.

35. The method of claim 34 further comprising the step of introducing a polymer to the acid solution to encapsulate the core.

36. The method of claim 34, wherein the oxidizing agent is selected from the group consisting of a peroxymonosulfate, a permanganate, a dichromate, a chromate, a bromate salt, a hypochlorite salt, a chlorate, a perchlorate, a periodate, a nitrate, a metal oxide, ozone or oxygen.

37. The method of claim 34, wherein the step of controlling the reaction comprises the steps of:
maintaining pH of the acid solution below 7; and
bubbling the oxidizing agent through the acid solution.
